(19) United States
(12) Patent Application Publication
(10) Pub. No.: US 2004/0009393 A1
(43) Pub. Date: Jan. 15, 2004

(54) Electrolyte of lithium-sulfur batteries and lithium-sulfur batteries comprising the same

(75) Inventors: Seok Kim, Incheon-City (KR); Yongju Jung, Suwon-City (KR); Jan-Dee Kim, Seoul (KR)

Correspondence Address: STAAS & HALSEY LLP, SUITE 700, 1201 NEW YORK AVENUE, N.W., WASHINGTON, DC, 20005, US

(73) Assignee: SAMSUNG SDI CO., LTD, Suwon-city (KR)

(21) Appl. No.: 10/617,230

(22) Filed: Jul. 11, 2003

(30) Foreign Application Priority Data
Jul. 12, 2002 (KR) 2002-40707

(51) Int. Cl. H01M 10/40; H01M 4/58

(52) U.S. Cl. 429/188; 429/330; 429/218.1; 429/340; 429/341

(57) ABSTRACT

An electrolyte for use in a lithium-sulfur battery includes salts having imide anions. The electrolyte may further include salts having organic cations. When lithium-sulfur batteries include salts having imide anions as electrolytes, the sulfur utilization is increased, and cycle life characteristics and discharge characteristics such as discharge capacity and average discharge voltage are improved.

### CROSS-REFERENCE TO RELATED APPLICATIONS

This application claims the benefit of Korean Application No. 2002-40707, filed Jul. 12, 2002, in the Korean Intellectual Property Office, the disclosure of which is incorporated herein by reference.

### BACKGROUND OF THE INVENTION

1. Field of the Invention

The present invention relates to lithium-sulfur batteries, and more specifically, to an electrolyte for use in a lithium-sulfur battery having excellent electrochemical properties such as battery capacity, high rate performance, cycle life, and performance at a low temperature.

2. Description of the Related Art

The development of portable electronic devices has led to a corresponding increase in the demand for secondary batteries having both a lighter weight and a higher capacity. To satisfy these demands, the most promising approach is a lithium-sulfur battery with a positive electrode made of sulfur-based compounds.

Lithium-sulfur batteries use sulfur-based compounds with sulfur-sulfur bonds as a positive active material, and a lithium metal or a carbon-based compound as a negative active material. The carbon-based compound is one which can reversibly intercalate or deintercalate metal ions, such as lithium ions. Upon discharging (i.e., electrochemical reduction), the sulfur-sulfur bonds are cleaved, resulting in a decrease in the oxidation number of sulfur (S). Upon recharging (i.e., electrochemical oxidation), the sulfur-sulfur bonds are reformed, resulting in an increase in the oxidation number of the S. The electrical energy is stored in the battery as the chemical energy during charging, and it is converted back to electrical energy during discharging.

With respect to specific density, the lithium-sulfur battery is the most attractive among the currently developing batteries since lithium has a specific capacity of 3,830 mAh/g, and sulfur has a specific capacity of 1,675 mAh/g. Further, the sulfur-based compounds are less costly than other materials and are environmentally friendly.

Nevertheless, no lithium-sulfur batteries have yet been made widely commercially available. One reason these batteries have not been able to be commercialized thus far is due to the poor sulfur utilization over repeated cycling, resulting in a low capacity. The sulfur utilization is referred to as a ratio of the amount of the sulfur involved in the electrochemical redox reaction of batteries to the amount of total injected sulfur. Further, the sulfur is diffused away to electrolytes upon the redox reaction, deteriorating the cycle life characteristics. Accordingly, unless the electrolyte is suitable, the reduced product of the sulfur, lithium sulfide (Li₂S), is deposited, and as a result does not participate in further electrochemical reactions.

U.S. Pat. No. 6,030,720 describes liquid electrolyte solvents including a main solvent having the general formula R₁(CH₂CH₂O)ₙR₂, where n ranges between 2 and 10, R₁ and R₂ are different or identical alkyl or alkoxy groups, and having a donor solvent of a donor number of 15 or more. Further, it includes a liquid electrolyte solvent, including a solvent having at least one of a crown ether, a cryptand, and a donor solvent, which are solvents generating a catholyte after discharging. Despite using this kind of electrolyte, however, the lithium-sulfur batteries have failed to obtain satisfactory capacity, high rate performance, or desired cycle life characteristics.

According to current research, an electrolyte of salts and an organic solvent are anticipated to provide lithium ion batteries with a high ion conductivity and a high oxidation potential. In such lithium ion batteries, lithium salts such as LiCIO₄, LiBF₄, or LiPF₆ are generally used. U.S. Pat. No. 5,827,602 describes non-aqueous batteries having lithium salts comprising triflate, imide, or methide-based anions. The aforementioned electrolyte shows good performance for lithium ion batteries. However, in lithium-sulfur batteries, the electrolyte causes problems by deteriorating the battery performance. This deterioration is due to the electrochemical reaction of the polysulfide being very unstable in a carbonate-based electrolyte, which is the most commonly used electrolyte in lithium-ion batteries. Thus, the lithium-sulfur batteries cannot effectively use the electrolyte present in the lithium-ion batteries. The electrolyte usable in lithium-sulfur batteries requires a stable electrochemical reaction with the polysulfide and requires the highly concentrated polysulfide generated by the reaction to be dissolvable.

Recently, attention has been drawn to a liquid-phase imidazolium cation-based salt usable at room temperature, commercially available as IONIC LIQUIDS. These cation-based salts are non-aqueous electrolyte salts capable of being applied to an electrical storage device such as a high-capacity capacitor or a battery (Koch, et al., J. Electrochem. Soc., Vol. 143, p. 155, 1996). As disclosed in U.S. Pat. No. 5,965,054, a non-aqueous electrolyte containing a liquid salt such as 1-ethyl-3-methylimidazolium hexafluorophosphate (EMIPF₆) is useful, having a high conductivity (>13 mS/cm), a large window of electrochemical stability (>2.5 V), a high salt concentration (>1 M), a high thermal stability (>100 C.), and a large capacitance (>100 F/g) from an activated carbon electrode, in a double-layer capacitor.

Further, U.S. Pat. No. 5,965,054 discloses a liquid salt and an electrolyte in which the liquid salt is mixed with various carbonate-based organic solvents (J. Electrochem. Soc. Vol. 146, p. 1687, 1999). The electrolyte shows improved characteristics, such as a high ion conductivity (>60 mS/cm), a large window of electrochemical stability (>4 V at 20 mA/cm²), and a higher salt concentration (>3 M). U.S. Pat. No. 5,973,913 discloses that, when the electrical storage devices such as an electrochemical capacitor or a battery have used the electrolytes including the above-mentioned liquid salts, improved characteristics, such as a high capacitance and a high energy density, are obtained.

However, despite the fact that the battery performance depends upon the kind and composition of the salt and organic solvent used in the electrolytes, none of the above-mentioned patents and articles concretely disclose an optimum kind and composition of salts and organic solvents for lithium-sulfur batteries, where the salts provide a high capacity, an excellent high rate performance, and a good performance at a low temperature. Particularly, lithium-sulfur batteries having liquid salts have thus far not been developed.

### SUMMARY OF THE INVENTION

It is an aspect of the present invention to provide a lithium-sulfur battery having a high capacity, effective cycle life characteristics, high rate performances and performance at a low temperature.

Additional aspects and advantages of the invention will be set forth in part in the description which follows and, in part, will be obvious from the description, or may be learned by practice of the invention.

In order to realize the above and other aspects, the present invention provides an electrolyte for use in a lithium-sulfur battery that includes salts having imide anions.

According to another embodiment of the present invention, a lithium-sulfur battery includes a positive electrode having at least one positive active material selected from the group consisting of an elemental sulfur, Li2Sn (n≧1), Li2Sn (n≧1) dissolved in catholytes, an organosulfur compound, and a carbon-sulfur polymer ((C2Sx)n: x=2.5˜50, n≧2); an electrolyte that includes salts having imide anions; and a negative electrode having a negative active material selected from the group consisting of a material capable of reversibly intercalating/deintercalating lithium ions, a material capable of reversibly forming a lithium-containing compound by a reaction with lithium ions, a lithium metal, and a lithium alloy.

### BRIEF DESCRIPTION OF THE DRAWINGS

These and/or other aspects and/or advantages of the invention will become apparent and more readily appreciated from the following description of the preferred embodiments, taken in conjunction with the accompanying drawings of which:

FIG. 1 is a perspective view of a battery according to an embodiment of the present invention.

FIG. 2 illustrates a graph showing cycle life characteristics of cells fabricated according to Examples 1 and 2 and Comparative Examples 1 and 2;

FIG. 3 illustrates a graph showing cycle life characteristics of cells fabricated according to Examples 3 to 6;

FIG. 4 illustrates a graph showing cycle life characteristics of cells fabricated according to Examples 7 and 8;

FIG. 5 illustrates a graph showing cycle life characteristics of cells fabricated according to Examples 9 and 10; and

FIG. 6 illustrates a graph showing energy density of cells according to Examples 1 and 2 and Comparative Examples 1 and 2.

### DETAILED DESCRIPTION OF THE PREFERRED EMBODIMENTS

Reference will now be made in detail to the present preferred embodiments of the present invention, examples of which are illustrated in the accompanying drawings, wherein like reference numerals refer to the like elements throughout. The embodiments are described below in order to explain the present invention by referring to the figures.

When lithium-sulfur batteries are discharged, elemental sulfur (S₈) is reduced, generating sulfide (S⁻²) or polysulfide (Sₙ⁻¹, Sₙ⁻², wherein, n≧2). Thus, lithium-sulfur batteries use the elemental sulfur, lithium sulfide (Li₂S) or lithium polysulfide (Li₂Sₙ, wherein n=2, 4, 6,or 8) as a positive active material. Among these sulfur sources, the elemental sulfur has a low polarity, while the lithium sulfide and the lithium polysulfide have a high polarity. Further, the lithium sulfide is present in a precipitated state, but lithium polysulfide is present in a dissolved state. In order to carry out an electrochemical reaction with the various states of the sulfur-based materials, it is important to select a suitable electrolyte to dissolve the various kinds of sulfur-based materials. Conventionally, the electrolyte used in lithium-sulfur batteries is an organic solvent that can dissolve solid-phase lithium salts.

According to a first embodiment of the present invention, the electrolyte used in a lithium-sulfur battery includes salts having imide anions.

The imide anion is represented by N(C_{X}F_{2X+1}SO₂)⁻N(C_{y}F_{2y+1}SO₂)⁻(wherein X and y are natural numbers). Exemplary imide anion includes bis(perfluoroethylsulfonyl)imide (N(C₂F₅SO₂)₂⁻, Beti), bis(trifluoromethylsulfonyl)imide (N(CF₃SO₂)₂⁻, Im), trifluoromethane sulfonimide, trifluoromethylsulfonimide, and the like. Among them, bis(perfluoroethylsulfonyl)imide (N(C₂F₅SO₂)₂⁻, Beti) and bis(trifluoromethylsulfonyl)imide (N(CF₃SO₂)₂⁻, Im) are most preferred.

The imide anion-containing salt is preferably used at a concentration of 0.3 M to 2.0 M. When the concentration falls within the above range, ionic conductivity of the electrolyte can be improved resulting in improvement of battery performance.

According to a second embodiment of the present invention, the electrolyte used in a lithium-sulfur battery includes first salts having imide anions and second salts having organic cations which have effective solubility for sulfur-based active material, and high ionic conductivity. The salts having imide anions facilitate a synergistic effect along with improving cycle life characteristics.

The salts having the organic cation do not contain lithium ions. Further, the stability of the battery can be improved since it has a low vapor pressure and a high flash point, thus being non-combustible. The battery also has the advantages of a lack of corrosiveness and a capability to be processed in a film form, which is mechanically stable. The salts of the present invention comprise relatively large-sized organic cations having a van der Waals volume of 100 Å³ or more, but it is understood that other sizes can be used. As the van der Waals volume increases, the lattice energy decreases, which results in enhancing ion conductivity. The electrolyte therefore is able to improve the sulfur utilization in a lithium-sulfur battery.

According to the embodiments of the invention, the salt may be present in a liquid state at a broad range of temperatures, particularly at a working temperature at which the liquid salt is capable of being used as an electrolyte. Thus, the salt is present in a liquid state at a temperature of 100° C. or lower, preferably at 50° C. or lower, and more preferably, 25° C. or lower. However, it is understood that other working temperatures are possible depending on the application.

While other cations may be used, the organic cation of the salt is preferably a cation of heterocyclic compounds. The heteroatom of the heterocyclic compound is selected from N, O, or S, or a combination thereof. The number of heteroatoms is from 1 to 4, and preferably 1 or 2. Examples of the cation of the heterocyclic compound include, but are not limited to, one selected from the group consisting of pyridinium, pyridazinium, pyrimidinium, pyrazinium, imidazolium, pyrazolium, thiazolium, oxazolium, and triazolium, or substitutes thereof. Preferably, the organic cation includes a cation of an imidazolium compound such as 1-ethyl-3-methylimidazolium (EMI), 1,2-dimethyl-3-propylimidazolium (DMPI), 1-butyl-3-methylimidazolium (BMI), and the like.

The anion to be linked with the cation is at least one selected from the group consisting of bis(perfluoroethylsulfonyl)imide (N(C₂F₅SO₂)₂⁻, Beti), bis(trifluoromethylsulfonyl)imide (N(CF₃SO₂)₂⁻, Im), tris(trifluoromethylsulfonyl)methide (C(CF₃SO₂)₂⁻, Me), trifluoromethane sulfonimide, trifluoromethylsulfonimide, trifluoromethylsulfonate, AsF₉⁻, ClO₄⁻, PF₆⁻, and BF₄⁻.

According to a third embodiment of the present invention, the electrolyte used in a lithium-sulfur battery includes first salts having lithium cations and imide anions, and second salts having organic cations.

Any salts wherein lithium cations are ionically bound with imide anions can be used as the first salts. The second salts having organic cations are the same as described above.

According to a fourth embodiment of the present invention, the electrolyte used in a lithium-sulfur battery includes first salts selected from the group consisting of LiN(CF₃SO₂)₂, LiN(C₂F₅SO₂)₂, and mixtures thereof; and second salts selected from the group consisting of 1-ethyl-3-methylimidazolium bis(perfluoroethylsulfonyl)imide (EMIBeti), 1-butyl-3-methylimidazolium hexafluorophosphate (BMIPF₆), and mixtures thereof.

In the preferred embodiments of the present invention, the first salts having imide anions are used at a concentration of 0.5 M to 2.0 M, and the second salts having organic cations are used at a concentration of 0.2 to 1 M. When the concentrations of first and second salts fall within the above ranges, the cycle life characteristics, the energy density, and high rate characteristics of the lithium-sulfur battery can be improved.

The electrolyte of the preferred embodiments of the present invention may further include an organic solvent as well as the salts having the imide anions, or the mixture including the salts having imide anions and the salts having organic cations. The organic solvent includes any conventional organic solvent used in a lithium-sulfur battery. Examples of the organic solvent include, but are not limited to, dimethoxy ethane, dioxolane, and the like. The content of organic solvent is 50 to 90% by volume of total electrolyte. The content of the dimethoxy ethane is from 50 to 90% by volume, and is preferably from 50 to 80% by volume, of the total electrolyte. The dioxolane is used between 50 and 60% by volume of the total electrolyte.

The organic solvent is either a single component solvent, or a mixed organic solvent that includes two or more of the organic components as in the present inventive electrolyte. According to an embodiment of the invention using the mixed organic solvent, the mixed organic solvent includes at least two groups selected from a weak polar solvent group, a strong polar solvent group and a lithium protecting solvent group. However, the mixed organic solvent need not include the at least two groups in all circumstances.

The term “weak polar solvent,” as used herein, is defined as a solvent capable of dissolving elemental sulfur and having a dielectric constant of less than 15. The weak polar solvent is selected from an aryl compound, a bicyclic ether, or an acyclic carbonate.

The term “strong polar solvent,” as used herein, is defined as a solvent capable of dissolving lithium polysulfide and having a dielectric constant of more than 15. The strong polar solvent is selected from a bicyclic carbonate compound, a sulfoxide compound, a lactone compound, a ketone compound, an ester compound, a sulfate compound, or a sulfite compound.

The term “lithium protecting solvent,” as used herein, is defined as a solvent capable of providing the surface of the lithium metal with a good protective layer (i.e., a stable solid-electrolyte interface (SEI) layer), and capable of showing an effective cycle efficiency of 50% or more. The lithium protecting solvent is selected from a saturated ether compound, an unsaturated ether compound, or a heterocyclic compound including N, O, or S, or a combination thereof.

Examples of the weak polar solvents include, but are not limited to, xylene, dimethoxyethane, 2-methyltetrahydrofuran, diethyl carbonate, dimethyl carbonate, toluene, dimethyl ether, diethyl ether, diglyme, tetraglyme, and so on.

Examples of the strong polar solvents include, but are not limited to, hexamethyl phosphoric triamide, [symbol] -butyrolactone, acetonitrile, ethylene carbonate, propylene carbonate, N-methyl pyrrolidone, 3-methyl-2-oxazolidone, dimethyl formamide, sulfolane, dimethyl acetamide, dimethyl sulfoxide, dimethyl sulfate, ethylene glycol diacetate, dimethyl sulfite, ethylene glycol sulfite, and so on.

Examples of the lithium protecting solvents include, but are not limited to, tetrahydrofuran, ethylene oxide, dioxolane, 3,5-dimethylisoxazole, 2,5-dimethyl furan, furan, 2-methylfuran, 1,4-oxane, 4-methyldioxolane, and so on.

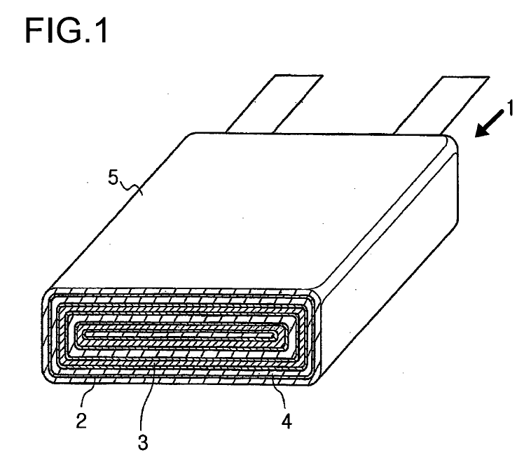

As shown in FIG. 1, a lithium-sulfur battery 1 according to an embodiment of the present invention includes a case 5 containing a positive electrode 3, a negative electrode 4, and a separator 2 interposed between the positive electrode 3 and the negative electrode 4. An electrolyte is disposed between the positive and negative electrodes 3 and 4 and includes a salt having an imide anion.

The positive electrode 3 includes sulfur-based compounds for a positive active material, which include at least one selected from the group consisting of elemental sulfur, Li₂Sₙ (wherein n≧1), Li₂Sₙ (wherein n≧1) dissolved in a catholyte, an organosulfur compound, and a carbon-sulfur polymer ((C₂Sₓ)ₙ: wherein x=2.5˜50, n≧2).

According to a fifth embodiment, the positive electrode 3 may optionally include at least one additive selected from the group consisting of a transition metal, a Group IIIA element, a Group IVA element, a sulfur compound thereof, and alloys thereof. The transition metal is preferably, but not limited to, at least one selected from the group consisting of Sc, Ti, V, Cr, Mn, Fe, Co, Ni, Cu, Zn, Y. Zr, Nb, Mo, Tc, Ru, Rh, Pd, Ag, Cd, Ta, W, Re, Os, Ir, Pt, Au, and Hg. The Group IIIA elements preferably include Al, Ga, In, and TI, and the group IVA elements preferably include Si, Ge, Sn, and Pb.

According to a sixth embodiment of the present invention, the positive electrode 3 further includes electrically conductive materials that facilitate the movement of the electrons within the positive electrode. Examples of the conductive materials include, but are not limited to, a conductive material such as graphite or carbon-based materials, or a conductive polymer. The graphite based material includes KS 6 (manufactured by TIMCAL COMPANY), the carbon-based material includes SUPER P (manufactured by MMM COMPANY), ketjen black, denka black, acetylene black, carbon black, and so on. Examples of the conductive polymer include, but are not limited to, polyaniline, polythiophene, polyacetylene, polypyrrole, and so on. The conductive material can be used singularly or as a mixture of two or more thereof, according to embodiments of the invention.

According to a seventh embodiment, a binder is added to enhance the adherence of the positive active material to the current collector. Examples of the binder include poly(vinyl acetate), poly vinyl alcohol, polyethylene oxide, polyvinyl pyrrolidone, alkylated polyethylene oxide, cross-linked polyethylene oxide, polyvinyl ether, poly(methyl methacrylate), polyvinylidene fluoride, a copolymer of polyhexafluoro propylene and polyvinylidene fluoride (marketed under the name of KYNAR), poly(ethyl acrylate), polytetrafluoro ethylene, polyvinyl chloride, polyacrylonitrile, polyvinylpyridine, polystyrene, and derivatives, blends, and copolymers thereof.

A method of preparing a positive electrode 3 according to an embodiment of the invention will now be described in more detail. A binder is dissolved in a solvent, and a conductive material is dispersed therein to obtain a dispersion solution. Any solvent may be used as long as it is capable of homogeneously dispersing a sulfur-based compound, the binder, and the conductive material. Useful solvents include, but are not limited to, acetonitrile, methanol, ethanol, tetrahydrofuran, water, isopropyl alcohol, dimethyl formamide, and so on.

A sulfur-based compound and an optional additive are homogeneously dispersed in the dispersion solution to prepare a positive electrode slurry. The amounts of the solvent, the sulfur compound, and the optional additive are not critical, but are sufficient to provide a suitable viscosity such that the slurry can easily be coated.

The prepared slurry is coated onto a current collector, and the coated collector is vacuum dried to prepare a positive electrode. The slurry is coated to a certain thickness, depending on the viscosity of the slurry and the thickness of the positive electrode to be prepared. Examples of the current collector include, but are not limited to, a conductive material such as stainless steel, aluminum, copper, or titanium. It generally is preferable to use a carbon-coated aluminum current collector. The carbon-coated aluminum current collector has excellent adhesive properties for adhering to the active materials, shows a lower contact resistance, and shows a better resistance to corrosion caused by the polysulfide, as compared to an uncoated aluminum current collector.

The negative electrode includes a negative active material selected from a material in which the lithium intercalation reversibly occurs, materials in which a lithium-containing compound is reversibly generated by reacting with lithium ions, lithium alloys, and lithium metals. The materials in which lithium intercalation reversibly occurs are carbon-based compounds. Any carbon material may be used as long as it is capable of intercalating and deintercalating lithium ions. Examples of the carbon material include, but are not limited to, crystalline carbon, amorphous carbon, or a mixture thereof. Further, examples of materials in which a lithium-containing compound is reversibly generated by reacting with lithium ions include, but are not limited to, tin dioxide (SnO₂), titanium nitrate, silicon, and the like. Examples of the metals capable of forming the lithium alloys include, but are not limited to, Na, K, Rb, Cs, Fr, Be, Mg, Ca, Sr, Ba, Ra, Al, and Sn.

A material laminated with an inorganic protective layer, an organic protective layer, or a mixture thereof on the surface of the lithium metal is used as a negative electrode according to embodiments of the invention. Examples of the materials used as an inorganic protective layer include, but are not limited to, a material selected from the group consisting of Mg, Al, B, C, Sn, Pb, Cd, Si, In, Ga, lithium silicate, lithium borate, lithium phosphate, lithium phosphornitride, lithium silicosulfide, lithium borosulfide, lithium aluminosulfide and lithium phophosulfide. Examples of the organic protective materials include, but are not limited to, conductive monomers, oligomers, or polymers selected from the group consisting of poly(p-phenylene), polyacetylene, poly(p-phenylene vinylene), polyanyline, polypyrrol, polythiophene, poly(2,5-ethylene vinylene), acetylene, poly(perinaphthalene), polyacene, and poly(naphthalene-2,6-diyl).

Further, during the charging and discharging of the lithium-sulfur batteries, the sulfur used as a positive active material may be inactivated and may be attached to the surface of the lithium negative electrode. The inactive sulfur is a sulfur that is incapable of being involved in a further electrochemical reaction of the positive electrode resulting from undergoing a variety of electrochemical or chemical reactions. On the other hand, the inactive sulfur has advantages in that it forms a protective layer for the lithium negative electrode. Accordingly, the lithium metals and the inactive sulfur formed on the lithium metal, for example, lithium sulfide, may be used as the negative electrode.

A porosity of the electrode is a very important factor in determining the amount of impregnation of an electrolyte. If the porosity is very low, discharging occurs locally, which causes unduly concentrated lithium polysulfide and makes precipitation easy, which decreases the sulfur utilization. Meanwhile, if the porosity is very high, the slurry density becomes low, so that it is difficult to prepare a battery with a high capacity. Thus, the porosity of the positive electrode according to an embodiment of the invention is at least 5% of the volume of the total positive electrode, preferably at least 10%, and more preferably 15 to 50%.

According to additional embodiments of the invention, a polymer layer of polyethylene or polypropylene, or a multi-layer thereof is used as a separator between the positive electrode and the negative electrode.

Hereinafter, the present invention will be explained in detail with reference to specific examples. These specific examples, however, should not in any sense be interpreted as limiting the scope of the present invention and equivalents thereof.

### EXAMPLE 1

1.0 M LiN(CF₃SO₂)₂ was dissolved in a mixed solvent of dimethoxyethane/dioxolane in the volume ratio of 4:1 to obtain a electrolyte.

67.5 wt. % elemental sulfur, 11.4 wt. % ketjen black as a conductive material, and 21.1 wt. % polyethylene oxide as a binder were mixed in an acetonitrile solvent to prepare a positive active material slurry for a lithium-sulfur battery cell. The slurry was coated on a carbon-coated Al current collector. The slurry-coated current collector was dried in a vacuum oven at 60° C. for more than 12 hours. Thus, the positive electrode with a current density of 2 mAh/cm² was prepared to 25×50 mm² in size. The positive electrode, the vacuum dried separator, and the negative electrode were laminated and transferred into a pouch. Then, the pouch was sealed and the resultant pouch-type test cell was fabricated.

### EXAMPLE 2

A cell was fabricated by the same procedure as described in Example 1, except that an electrolyte of 1.0 M LiN(C₂F₅SO₂)₂ in a mixed solvent of dimethoxyethane/dioxolane (4:1 volume ratio) was used.

### EXAMPLE 3

A cell was fabricated by the same procedure as described in Example 1, except that an electrolyte of 0.5 M LiSO₃CF₃ and 0.45 M 1-ethyl-3-methylimidazolium bis(trifluoromethyl sulfonyl) imide (EMIIm) in a mixed solvent of dimethoxyethane/dioxolane (4:1 volume ratio) was used.

### EXAMPLE 4

A cell was fabricated by the same procedure as described in Example 1, except that an electrolyte of 0.5 M LiSO₃CF₃ and 0.32 M 1-ethyl-3-methylimidazolium bis(perfluoroethyl sulfonyl) imide (EMIBeti) in a mixed solvent of dimethoxyethane/dioxolane (4:1 volume ratio) was used.

### EXAMPLE 5

A cell was fabricated by the same procedure as described in Example 1, except that an electrolyte of 0.5 M LiSO₃CF₃ and 0.45 M 1-butyl-3-methylimidazolium bis(trifluoromethyl sulfonyl) imide (BMIIm) in a mixed solvent of dimethoxyethane/dioxolane (4:1 volume ratio) was used.

### EXAMPLE 6

A cell was fabricated by the same procedure as described in Example 1, except that an electrolyte of 0.5 M LiSO₃CF₃ and 0.32 M 1-butyl-3-methylimidazolium bis(perfluoroethyl sulfonyl) imide (BMIBeti) in a mixed solvent of dimethoxyethane/dioxolane (4:1 volume ratio) was used.

### EXAMPLE 7

A cell was fabricated by the same procedure as described in Example 1, except that an electrolyte of 0.5 M LiN(CF₃SO₂)₂ and 0.32 M 1-ethyl-3-methylimidazolium bis(perfluoroethyl sulfonyl) imide (EMIBeti) in a mixed solvent of dimethoxyethane/dioxolane (4:1 volume ratio) was used.

### EXAMPLE 8

A cell was fabricated by the same procedure as described in Example 1, except that an electrolyte of 0.5 M LiN(CF₃SO₂)₂ and 0.48 M 1-butyl-3-methylimidazolium hexafluorophosphate (BMIPF₆) in a mixed solvent of dimethoxyethane/dioxolane (4:1 volume ratio) was used.

### EXAMPLE 9

A cell was fabricated by the same procedure as described in Example 1, except that an electrolyte of 0.5 M LiN(C₂F₅SO₂)₂ and 0.32 M 1-ethyl-3-methylimidazolium bis(perfluoroethyl sulfonyl) imide (EMIBeti) in a mixed solvent of dimethoxyethane/dioxolane (4:1 volume ratio) was used.

### EXAMPLE 10

A cell was fabricated by the same procedure as described in Example 1, except that an electrolyte of 0.5 M LiN(C₂F₅SO₂)₂ and 0.48 M 1-butyl-3-methylimidazolium hexafluorophosphate (BMIPF₆) in a mixed solvent of dimethoxyethane/dioxolane (4:1 volume ratio) was used.

### Comparative Example 1

A cell was fabricated by the same procedure as described in Example 1, except that an electrolyte of 1 M LiSO₃CF₃ in a mixed solvent of dimethoxyethane/dioxolane (4:1 volume ratio) was used.

### Comparative Example 2

A cell was fabricated by the same procedure as described in Example 1, except that an electrolyte of 1 M LiPF₆ in a mixed solvent of dimethoxyethane/dioxolane (4:1 volume ratio) was used.

Evaluation of Cycle Life Characteristics

Cycle life characteristics of the test cells according to Examples 1 to 10 and Comparative Examples 1 and 2 were evaluated at an ambient temperature. The lithium-sulfur battery was initially discharged for 1 cycle at a discharging current density of 0.2 mA/cm², since the test cell had been charged on cell formation. To monitor the change of the capacity depending upon the discharge current, a charge current density was set to 0.4 mA/cm² and the discharge current density was varied to 0.2, 0.4, 1.0, and 2.0 mA/cm² (C-rate is 0.1 C, 0.2 C, 0.5 C, and 1 C, respectively) for 1 cycle, then the discharge current density was set to 1.0 mA/cm² (0.5 C), followed by charging and discharging for 100 cycles. The discharge cut-off voltage was set to 1.5˜2.8 V.

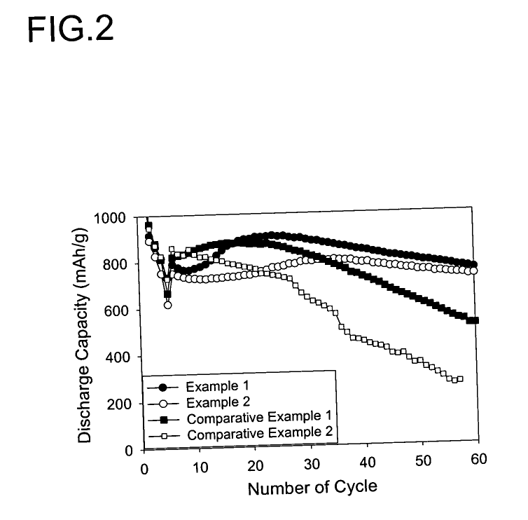

FIG. 2 shows the cycle life characteristics by the number of cycles of cells according to Examples 1 and 2 and Comparative Examples 1 and 2. The capacities of Examples 1 and 2 were maintained at excellent levels through 1 to 60 cycles, but the capacities of Comparative Examples 1 and 2 significantly decreased after 30 cycles.

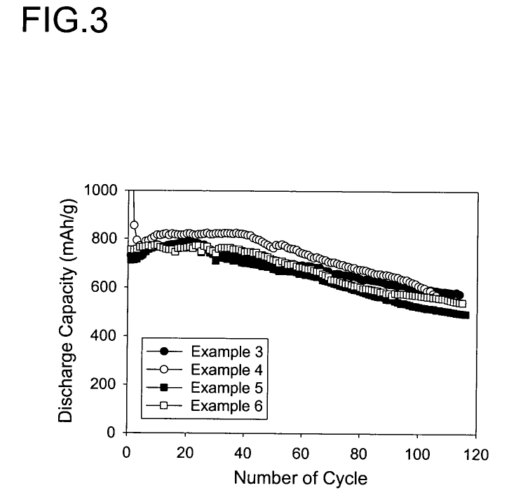

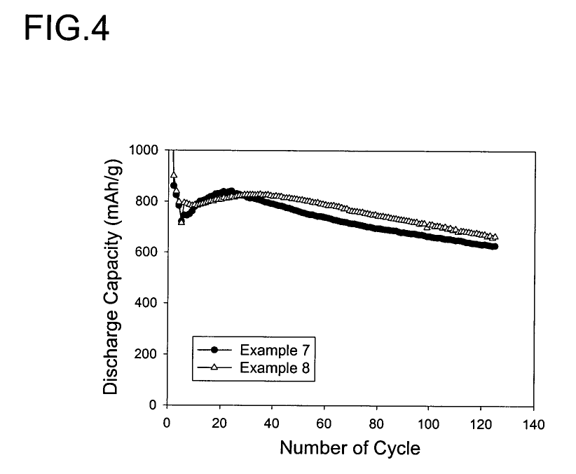

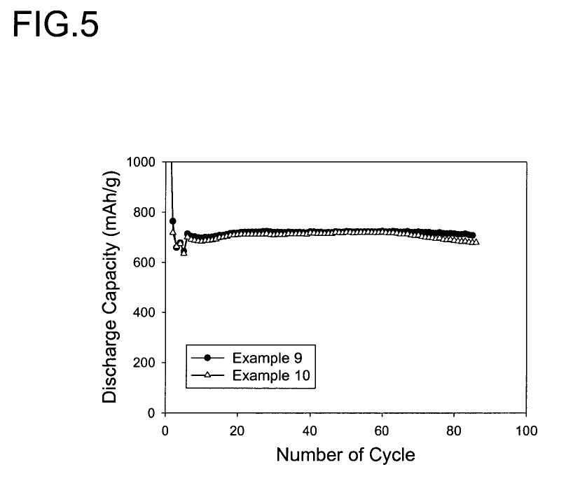

FIG. 3 shows the cycle life characteristics by the number of cycles of cells according to Examples 3 to 6; FIG. 4 shows the cycle life characteristics by the number of cycles of cells according to Examples 7 and 8; and FIG. 5 shows the cycle life characteristics by the number of cycles of cells according to Examples 9 and 10. As shown in FIGS. 3 to 5, the cells according to the inventive Examples have cycle life characteristics superior to the Comparative Examples.

It is shown that the cells according to the inventive Examples have superior sulfur utilization and stable cycle life characteristics.

Evaluation of Discharging Characteristics

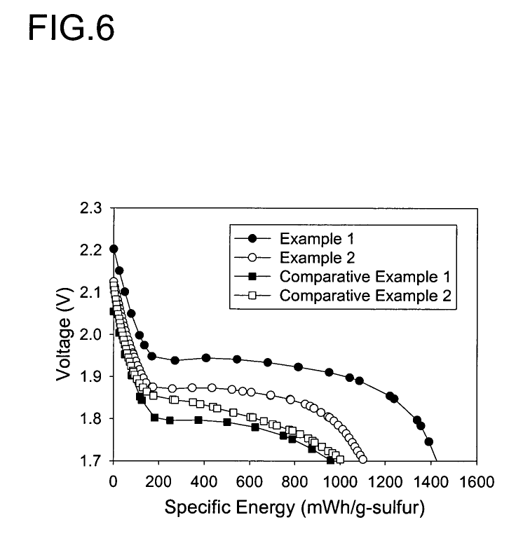

The charge and discharge evaluation was performed with the same procedure as described in evaluating the cycle life characteristics, except that the cut-off voltage was 1.7˜2.8 V. FIG. 6 shows the results of Examples 1 and 2 and Comparative Examples 1 and 2 when the discharge current density was 1.0 mA/cm² (0.5 C). The specific energy (mWh/g) was calculated by measuring an average discharge voltage and discharge capacity. In FIG. 6, the x-axis represents specific density (average discharge voltage X discharge capacity), while the y-axis represents voltage.

As shown in FIG. 6, the cells of Examples 1 and 2 are superior to the cells of Comparative Examples 1 and 2 in terms of values of the average discharge voltage and specific energy density. Therefore, the cells of Examples 1 and 2 have excellent discharge characteristics. The cells of Examples 3˜10 also have higher average discharge voltages and specific energy densities in comparison with the cells of Comparative Example 1and 2.

In the Reference examples below, the electrochemical characteristics were evaluated when the electrolyte of the inventive lithium-sulfur batteries was used for lithium-ion batteries.

### Reference Example 1

A binder (polyvinylidene fluoride) was added to N-methyl pyrrolidone (NMP) to provide a binder solution. A conductive material (SUPER P) and a positive active material of LiCoO₂ with an average particle size of 10 μm were added to the binder solution to prepare a positive active material slurry for a lithium-sulfur battery. The weight ratio for the positive active material/conductive material/binder was 96:2:2. The slurry was coated on a carbon-coated Al foil. Then, the slurry-coated Al-foil was dried in a vacuum oven at 60° C. for over 12 hours. The positive electrode with a density of 2 mAh/cm² was then prepared to 25×50 mm² in size. The positive electrode, the vacuum dried separator, and the negative electrode were laminated and transferred into a pouch. The electrolyte of 0.5 M LiSO₃CF₃ in the mixed solvent of ethylene carbonate and dimethyl carbonate in the volume ratio of 1:1 was injected into the pouch to provide a pouch-type lithium ion cell.

### Reference Example 2

A lithium ion cell was fabricated by the same procedure as described in Reference Example 1 except that an electrolyte of 0.5 M LiSO₃CF₃ and 0.48 M 1-butyl-3-methylimidazolium hexafluorophosphate (BMIPF₆) in a mixed solvent of dimethoxyethane/dioxolane (4:1 volume ratio) was used.

### Reference Example 3

A lithium ion cell was fabricated by the same procedure as described in Reference Example 1 except that an electrolyte of 0.5 M LiSO₃CF₃ and 0.48 M 1-butyl-3-methylimidazolium hexafluorophosphate (BMIPF₆) was used.

The lithium ion cells according to Reference Examples 2 and 3 have discharge capacities that are about 20% or less of that of Reference Example 1 and of about 10% or less of those of the above inventive Examples. Thus, the electrolyte that improves the lithium-sulfur batteries does not impart any improvements to the lithium-ion batteries. It seems that different electrolytes are required due to the difference in the active materials between the two kinds of batteries.

The lithium-sulfur batteries according to the present invention include salts having imide anions as electrolytes, resulting in increasing the sulfur utilization and improving cycle life characteristics and discharge characteristics such as discharge capacity and average discharge voltage, compared to conventional batteries using prior art electrolytes including organic solvents and lithium salts excluding imide anions.

While the present invention has been described in detail with reference to the preferred embodiments, those skilled in the art will appreciate that various modifications and substitutions can be made thereto without departing from the spirit and scope of the present invention as set forth in the appended claims.

Although a few preferred embodiments of the present invention have been shown and described, it would be appreciated by those skilled in the art that changes may be made in this embodiment without departing from the principles and spirit of the invention, the scope of which is define in the claims and their equivalents.

What is claimed is:

1. An electrolyte for use in a lithium-sulfur battery, comprising salts having imide anions.

2. The electrolyte of claim 1, wherein said imide anion is represented by N(CₓF₂ₓ₊₁SO₂)⁻N(C_{y}F_{2y+1}SO₂)⁻, wherein X and y are natural numbers .

3. The electrolyte of claim 1, wherein said imide anion is selected from the group consisting of bis(perfluoroethylsulfonyl)imide (N(C₂F₅SO₂)₂⁻, Beti), bis(trifluoromethylsulfonyl)imide (N(CF₃SO₂)₂⁻, Im), and trifluoromethane sulfonimide, trifluoromethylsulfonimide.

4. An electrolyte for use in a lithium-sulfur battery, comprising a first salt having imide anions and a second salt having organic cations.

5. The electrolyte of claim 4, wherein said second salt is present in a liquid state at working temperatures less than or equal to 100° C.

6. The electrolyte of claim 4, wherein the organic cation has a van der Waals volume of at least 100 Å³.

7. The electrolyte of claim 4, wherein the organic cation is a cation of a heterocyclic compound.

8. The electrolyte of claim 7, wherein the heterocyclic compound includes a heteroatom selected from N, O, S, or a combination thereof.

9. The electrolyte of claim 7, wherein the heterocyclic compound has a number of heteroatoms from 1 to 4, inclusive.

10. The electrolyte of claim 7, wherein the cation of the heterocyclic compound includes at least one selected from the group consisting of pyridinium, pyridazinium, pyrimidinium, pyrazinium, imidazolium, pyrazolium, thiazolium, oxazolium, and triazolium, and substitutes thereof.

11. The electrolyte of claim 4, wherein the organic cation includes a cation of an imidazolium compound.

12. The electrolyte of claim 11, wherein the imidazolium compound is at least one of 1-ethyl-3-methylimidazolium (EMI), 1,2-dimethyl-3-propylimidazolium (DMPI), and 1-byutyl-3-methylimidazolium (BMI).

13. The electrolyte of claim 4, wherein the second salt further comprises an anion to be linked with the organic cation and which is selected from the group consisting of bis(perfluoroethylsulfonyl)imide (N(C₂F₅SO₂)₂⁻, Beti), bis(trifluoromethylsulfonyl)imide (N(CF₃SO₂)₂⁻, Im), tris(trifluoromethylsulfonyl)methide (C(CF₃SO₂)₂⁻, Me), trifluoromethane sulfonimide, trifluoromethylsulfonimide, trifluoromethylsulfonate, AsF₉⁻, ClO₄⁻, PF₆⁻, and BF₄⁻.

14. The electrolyte of claim 4, wherein the first salt is selected from the group consisting of LiN(CF₃SO₂)₂, LiN(C₂F₅SO₂)₂, and mixtures thereof; and said second salt is selected from the group consisting of 1-ethyl-3-methylimidazolium bis(perfluoroethylsulfonyl)imide (EMIBeti), 1-butyl-3-methylimidazolium hexafluorophosphate (BMIPF₆), and mixtures thereof.

15. The electrolyte of claim 4, wherein the first salt is used at a concentration of 0.5 M to 2.0 M, and the second salt is used at a concentration of 0.2 to 1 M.

16. The electrolyte of claim 4, further comprising an organic solvent in which said salt is mixed.

17. The electrolyte of claim 16, wherein said organic solvent includes at least one of dimethoxy ethane, dioxolane and mixtures thereof.

18. The electrolyte of claim 17, wherein the organic solvent comprises at least two groups selected from a weak polar solvent group, a strong polar solvent group and a lithium protecting solvent group.

19. The electrolyte of claim 18, wherein:
the weak polar solvent is selected from an aryl compound, a bicyclic ether, and an acyclic carbonate,
the strong polar solvent is selected from a bicyclic carbonate compound, a sulfoxide compound, a lactone compound, a ketone compound, an ester compound, a sulfate compound, and a sulfite compound, and
the lithium protecting solvent is selected from a saturated ether compound, an unsaturated ether compound, a heterocyclic compound including N, O, and S, and a combination thereof.

20. An electrolyte for use in a lithium-sulfur battery, comprising: a first salt having lithium cations and imide anions; and a second salt having organic cations.

21. An electrolyte for use in a lithium-sulfur battery, comprising:
a first salt being selected from the group consisting of LiN(CF₃SO₂)₂, LiN(C₂F₅SO₂)₂, and mixtures thereof; and
a second salt being selected from the group consisting of 1-ethyl-3-methylimidazolium bis(perfluoroethylsulfonyl)imide (EMIBeti), 1-butyl-3-methylimidazolium hexafluorophosphate (BMIPF₆), and mixtures thereof.

22. A lithium-sulfur battery comprising:
a positive electrode having a sulfur, a sulfur compound and mixtures thereof as a positive active material;
an electrolyte for use in a lithium-sulfur battery, comprising salts having imide anions; and
a negative electrode having a negative active material selected from the group consisting of a material capable of reversibly intercalating/deintercalating lithium ions, a material capable of reversibly forming a lithium-containing compound by a reaction with lithium ions, a lithium metal, and a lithium alloy.

23. The lithium-sulfur battery of claim 22, wherein the positive active material is selected from the group consisting of an elemental sulfur, Li₂Sₙ (n≧1), Li₂Sₙ (n≧1) dissolved in catholytes, an organosulfur compound, and a carbon-sulfur polymer ((C₂Sₓ)ₙ: x=2.5˜50, n≧2).

24. The lithium-sulfur battery of claim 22, wherein the positive electrode further comprises at least one additive selected from the group consisting of a transition metal, a Group IIIA element, a Group IVA element, a sulfur compound thereof, and alloys thereof.

25. The lithium-sulfur battery of claim 22, wherein:
the transition metal is at least one selected from the group consisting of Sc, Ti, V, Cr, Mn, Fe, Co, Ni, Cu, Zn, Y, Zr, Nb, Mo, Tc, Ru, Rh, Pd, Ag, Cd, Ta, W, Re, Os, Ir, Pt, Au, and Hg,
the Group IIIA elements includes at least one of Al, Ga, In, and Tl, and
the group IVA elements includes at least one of Si, Ge, Sn, and Pb.

26. The lithium sulfur battery of claim 22, wherein the positive electrode further comprises electrically conductive materials that facilitate the movement of electrons within the positive electrode.

27. The lithium sulfur battery of claim 22, wherein:
the positive electrode further comprises a current collector and a binder to adhere the positive active material to the current collector, and
the binder includes at least one of poly(vinyl acetate), poly vinyl alcohol, polyethylene oxide, polyvinyl pyrrolidone, alkylated polyethylene oxide, cross-linked polyethylene oxide, polyvinyl ether, poly(methyl methacrylate), polyvinylidene fluoride, a copolymer of polyhexafluoro propylene and polyvinylidene fluoride, poly(ethyl acrylate), polytetrafluoro ethylene, polyvinyl chloride, polyacrylonitrile, polyvinylpyridine, polystyrene, and derivatives, blends, and copolymers thereof.
